(19) United States
(12) Patent Application Publication
(10) Pub. No.: US 2024/0305048 A1
(43) Pub. Date: Sep. 12, 2024

(54) WORKING MACHINE

(71) Applicant: MAKITA CORPORATION, Anjo-shi (JP)

(72) Inventor: Yuta KUTSUNA, Anjo-shi (JP)

(73) Assignee: MAKITA CORPORATION, Anjo-shi (JP)

(21) Appl. No.: 18/591,016

(22) Filed: Feb. 29, 2024

(30) Foreign Application Priority Data
Mar. 10, 2023 (JP) 2023-037962

(51) Int. Cl. H01R 13/73

(52) U.S. Cl. CPC H01R 13/73

(57) ABSTRACT

A working machine may include a first operation rod extending in a front-rear direction, a front unit disposed frontward of the first operation rod, a rear unit disposed rearward of the first operation rod, a first wire disposed in an interior of the first operation rod, a first terminal electrically connected to the first wire, a first connector housing holding the first terminal and configured to pass through the interior of the first operation rod in the front-rear direction, a retainer configured to retain the first connector housing at one end of the first operation rod, a second terminal, and a second connector housing holding the second terminal and configured to be detachably attached to the first connector housing. The first terminal and the second terminal may be electrically connected to each other by the first connector housing and the second connector housing being attached to each other.

### REFERENCE TO RELATED APPLICATIONS

This application claims priority to Japanese Patent Application No. 2023-37962 filed on Mar. 10, 2023. The entire content of the priority application is incorporated herein by reference.

### TECHNICAL FIELD

Art disclosed herein relates to a working machine.

### BACKGROUND ART

Japanese Patent Application Publication No. H10-89322 describes a working machine including: a first operation rod extending in a front-rear direction; a front unit disposed frontward of the first operation rod and including a working part; a rear unit disposed rearward of the first operation rod; a first wire disposed in an interior of the first operation rod; a first terminal electrically connected to the first wire; a first connector housing holding the first terminal; a second terminal; and a second connector housing holding the second terminal and configured to be detachably attached to the first connector housing. The first terminal and the second terminal are electrically connected to each other by the first connector housing and the second connector housing being attached to each other.

### SUMMARY

In the course of manufacturing a working machine, an operation of assembling a first connector housing and a first wire to a first operation rod (also referred to as “connector assembling operation” hereinafter) is performed. Since the working machine of Japanese Patent Application Publication No. H10-89322 has a limitation that the first connector housing cannot pass through the first operation rod, it is expected that it takes time and effort to perform the connector assembling operation. The disclosure herein provides a technology that allows for a reduction in time and effort to perform the connector assembling operation.

A working machine disclosed herein may comprise a first operation rod extending in a front-rear direction, a front unit disposed frontward of the first operation rod and comprising a working part, a rear unit disposed rearward of the first operation rod, a first wire disposed in an interior of the first operation rod, a first terminal electrically connected to the first wire, a first connector housing holding the first terminal and configured to pass through the interior of the first operation rod in the front-rear direction, a retainer configured to retain the first connector housing at one end of the first operation rod, a second terminal, and a second connector housing holding the second terminal and configured to be detachably attached to the first connector housing. The first terminal and the second terminal may be electrically connected to each other by the first connector housing and the second connector housing being attached to each other.

If the first connector housing is not configured to pass through the interior of the first operation rod, it is expected that it would take time and effort to release the connection between the first connector housing and the first wire in the connector assembling operation, or to disassemble the first operation rod. According to the above configuration, the first connector housing is configured to pass through the interior of the first operation rod. Therefore, the time and effort to release the connection between the first connector housing and the first wire or to disassemble the first operation rod can be saved during the connector assembling operation. Thus, the time and effort to perform the connector assembling operation can be reduced.

### BRIEF DESCRIPTION OF THE DRAWINGS

FIG. 1 shows a working machine 2 according to a first embodiment, as viewed from the upper front right side.

FIG. 2 shows an inner structure of a front unit 6 of the working machine 2 according to the first embodiment, as viewed from the upper front right side.

FIG. 3 shows an inner structure of a rear unit 8 of the working machine 2 according to the first embodiment, as viewed from the upper front right side.

FIG. 4 shows an inner structure of an operation rod 4 of the working machine 2 according to the first embodiment, as viewed from the upper front right side.

FIG. 5 shows a first connector 62 of the working machine 2 according to the first embodiment with a retaining member 78 detached therefrom and its surrounding structure, as viewed from the upper front right side.

FIG. 6 shows the first connector 62 of the working machine 2 according to the first embodiment with the retaining member 78 detached therefrom and its surrounding structure, as viewed from the lower rear left side.

FIG. 7 shows how the first connector 62 is retained by the retaining member 78 at a front end of an intermediate rod 4m (a rear rod 4r) in the working machine 2 according to the first embodiment, as viewed from the upper front right side.

FIG. 8 shows how the first connector 62 is retained by the retaining member 78 at the front end of the intermediate rod 4m (the rear rod 4r) in the working machine 2 according to the first embodiment, as viewed from the front side.

FIG. 9 shows a second connector 64 of the working machine 2 according to the first embodiment and its surrounding structure, as viewed from the upper rear right side.

FIG. 10 shows how the second connector 64 is retained at a rear end of a front rod 4f (intermediate rod 4m) in the working machine 2 according to the first embodiment, as viewed from the upper rear right side.

FIG. 11 shows in a cross-sectional view how the front rod 4f and the intermediate rod 4m are connected to each other by a first connecting member 18 in the working machine 2 according to the first embodiment.

FIG. 12 shows in a cross-sectional view how the intermediate rod 4m and the rear rod 4r are connected to each other by a second connecting member 20 in the working machine 2 according to the first embodiment.

FIG. 13 shows in a cross-sectional view how multiply-connection of the intermediate rod 4m is prevented in the working machine 2 according to the first embodiment.

FIG. 14 shows a means for attaching the front rod 4f to the front unit 6 in the working machine 2 according to the first embodiment.

FIG. 15 shows a means for attaching the rear rod 4r to the rear unit 8 in the working machine 2 according to the first embodiment.

FIG. 16 shows a working machine 302 according to a second embodiment, as viewed from the upper front right side.

FIG. 17 shows a working machine 402 according to a third embodiment, as viewed from the upper front right side.

FIG. 18 shows a working machine 502 according to a fourth embodiment, as viewed from the upper front right side.

### DESCRIPTION

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved working machines as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, the retainer may comprise a retaining member configured to be detachably attached to the first connector housing. The retaining member may be configured to retain the first connector housing at the one end of the first operation rod.

For example, bonding the first connector housing to the first operation rod via an adhesive could be considered. However, if the first connector housing is bonded to the first operation rod in that way, it is difficult to detach the first connector housing from the first operation rod. Thus, it is difficult to redo the connector assembling operation. This could be a burden on the manufacturer. According to the configuration above, the retaining member, which retains the first connector housing with the first operation rod, is configured to be detachably attached to the first connector housing. Therefore, the connector assembling operation can be easily redone after it has once completed. Thus, the burden on the manufacturer of the working machine is reduced.

In one or more embodiments, the retaining member may comprise a stopper portion that protrudes outwardly beyond an outer surface of the first connector housing when the retaining member is attached to the first connector housing. The first connector housing may be retained at the one end of the first operation rod by the stopper portion contacting the first operation rod in the front-rear direction.

The configuration above allows the first connector housing to be retained with the first operation rod in a relatively simple manner.

In one or more embodiments, the stopper portion may comprise a first stopper portion and a second stopper portion circumferentially offset from the first stopper portion.

If the retaining member contacts the end of the first operation rod at only one point, the position of the first connector housing relative to the end of the first operation rod may not be stabilized. According to the configuration above, the retaining member contacts the end of the first operation rod at two or more points. Therefore, the position of the first connector housing relative to the end of the first operation rod can be stabilized.

In one or more embodiments, the stopper portion may further comprise a third stopper portion circumferentially offset from each of the first stopper portion and the second stopper portion.

According to the configuration above, the retaining member contacts the end of the first operation rod at three or more points. Therefore, the position of the first connector housing relative to the end of the first operation rod can be further stabilized.

In one or more embodiments, an outer surface of the stopper portion may be located inward of an outer surface of the first operation rod as viewed along the front-rear direction.

If the outer surface of the stopper portion is located outward of the outer surface of the first operation rod, problems may be thereby caused. For example, when a member is attached to the first operation rod from the outside, the stopper portion can interfere with the member. According to the configuration above, the outer surface of the stopper portion is located inward of the outer surface of the first operation rod, and thus such problems can be prevented. It should be noted that the wording “an outer surface is located inward of another outer surface” herein encompasses that the two outer surfaces are flush each other.

In one or more embodiments, the retaining member may comprise a press-fit portion configured to be inserted in the interior of the first operation rod through the one end of the first operation rod and be pressed between the outer surface of the first connector housing and an inner surface of the first operation rod.

Since the first connector housing is configured to pass through the interior of the first operation rod, a clearance is provided between the outer surface of the first connector housing and the inner surface of the first operation rod. Without this clearance being filled, the first connector housing may wobble against the first operation rod. According to the configuration above, the clearance is at least partially filled by the press-fit portion. This suppresses the first connector housing from wobbling against the first operation rod.

In one or more embodiments, the one end of the first operation rod may comprise a notch configured to receive the stopper portion in the front-rear direction.

In the configuration above, the notch receives the stopper portion, by which the first connector housing is suppressed from moving in a circumferential direction of the first operation rod. Therefore, the first operation rod and the first connector housing are positioned relative to each other in the circumferential direction of the first operation rod.

In one or more embodiments, the working machine may further comprise a connecting member disposed at the one end of the first operation rod. The connecting member may comprise a cylindrical portion into which the one end of the first operation rod is inserted. The retaining member may comprise a guide projection protruding outwardly beyond an outer surface of the first operation rod as viewed along the front-rear direction. The cylindrical portion may comprise a guide groove configured to slidably receive the guide projection in the front-rear direction.

In the configuration above, the guide groove receives the guide projection, by which the first connector housing is suppressed from moving in a circumferential direction of the cylindrical portion. Therefore, the connecting member and the first connector housing are positioned relative to each other in the circumferential direction of the cylindrical portion.

In one or more embodiments, the working machine may further comprise a connecting member disposed at the one end of the first operation rod. The connecting member may comprise a cylindrical portion into which the one end of the first operation rod is inserted. The cylindrical portion may comprise a support portion configured to contact the stopper portion from an opposite side to a side at which the one end of the first operation rod contacts the stopper portion.

According to the configuration above, the stopper portion is interposed between the end of the first operation rod and the support portion of the cylindrical portion in the front-rear direction. This suppresses the first connector housing from moving relative to the first operation rod and the connecting member in the front-rear direction. Therefore, the first connector housing is positioned relative to the first operation rod and the connecting member in the front-rear direction.

In one or more embodiments, the retaining member may comprise a band portion extending over more than a half of a periphery of the first connector housing, a first engaging portion protruding from one end of the band portion toward the first connector housing, and a second engaging portion protruding from other end of the band portion toward the first connector housing. The first connector housing may comprise a first recess corresponding to the first engaging portion and a second recess corresponding to the second engaging portion. In a state where the band portion is expanded radially outward by an outer surface of the first connector housing, the first engaging portion may engage the first recess and the second engaging portion engages the second recess.

Attaching the retaining member to the first connector housing using a fastener such as a pin could be considered. However, this increases the number of components and thus increases the manufacturing cost of the working machine. According to the configuration above, the retaining member can be attached to the first connector housing by using the elasticity of the retaining member without using a fastener. This allows for a reduction in the number of components and thus a reduction in the manufacturing cost of the working machine.

In one or more embodiments, other end of the first operation rod may be attached to the rear unit or the front unit in a difficult-to-remove manner.

A relatively heavy element (e.g., a battery pack) is expected to be provided in the rear unit (or the front unit). Therefore, the connection between the operation rod and the rear unit (or the front unit) is expected to bear a relatively large load. If the operation rod is attached to the rear unit (or the front unit) in an easy-to-remove manner, it is difficult to ensure rigidity that can bear the above load at the connection therebetween. According to the configuration above, the operation rod is attached to the rear unit (or the front unit) in a difficult-to-remove manner. In this configuration, the operation rod can be attached to the rear unit (or the front unit) relatively firmly. Therefore, rigidity that can bear the above load can be easily ensured at the connection between the operation rod and the rear unit (or the front unit). It should be noted that “a difficult-to-remove manner” herein means that the use of a tool (e.g., a screwdriver) is required for removal, that disassembly of the rear unit (or the front unit) is required for removal, or that destruction of the rear unit (or the font unit) or the operation rod is required for removal. Meanwhile, “an easy-to-remove manner” means that the use of a tool is not required for removal, that disassembly of the rear unit (or the front unit) is not required for removal, or that destruction of the rear unit (or the font unit) and the operation rod is not required for removal.

In one or more embodiments, the working machine may further comprise a second operation rod extending in the front-rear direction and disposed between the front unit and the rear unit and a second wire disposed in an interior of the second operation rod. The second operation rod may be configured such that one end of the second operation rod is detachably attached to the one end of the first operation rod. The second wire may be electrically connected to the second terminal. The second connector housing may be retained at the one end of the second operation rod.

The size of a working machine with an operation rod tends to be large in the front-rear direction. Therefore, the working machine may be difficult to store (or pack). The configuration above allows the working machine to be separated into the first operation rod and the second operation rod. This separation reduces the size of the working machine in the front-rear direction. Therefore, the working machine can be easily stored (or packed).

In one or more embodiments, other end of the second operation rod may be attached to the front unit or the rear unit in a difficult-to-remove manner.

A relatively heavy element (e.g., an electric motor) is expected to be provided in the front unit (or the rear unit). Therefore, the connection between the operation rod and the front unit (or the rear unit) is expected to bear a relatively large load. If the operation rod is attached to the front unit (or the rear unit) in an easy-to-remove manner, it is difficult to ensure rigidity that can bear the above load at the connection therebetween. According to the configuration above, the operation rod is attached to the front unit (or the rear unit) in a difficult-to-remove manner. In this configuration, the operation rod can be attached to the front unit (or the rear unit) relatively firmly. Therefore, rigidity that can bear the above load can be easily ensured at the connection between the operation rod and the front unit (or the rear unit).

In one or more embodiments, the working machine may further comprise a third operation rod extending in the front-rear direction and disposed between the front unit and the rear unit. The third operation rod may be configured such that one end of the third operation rod is detachably attached to other end of the second operation rod.

The configuration above allows the working machine to be separated not only into the first operation rod and the second operation rod but also into the third operation rod. Therefore, the working machine can be further reduced in size and thus the working machine can be more easily stored (or packed).

In one or more embodiments, other end of the third operation rod may be attached to the front unit or the rear unit in a difficult-to-remove manner.

A relatively heavy element (e.g., an electric motor) is expected to be provided in the front unit (or the rear unit). Therefore, the connection between the operation rod and the front unit (or the rear unit) is expected to bear a relatively large load. If the operation rod is attached to the front unit (or the rear unit) in an easy-to-remove manner, it is difficult to ensure rigidity that can bear the above load at the connection therebetween. According to the configuration above, the operation rod is attached to the front unit (or the rear unit) in a difficult-to-remove manner. In this configuration, the operation rod can be attached to the front unit (or the rear unit) relatively firmly. Therefore, rigidity that can bear the above load can be easily ensured at the connection between the operation rod and the front unit (or the rear unit).

In one or more embodiments, the rear unit may comprise a power interface configured to be electrically connected to a power source. The first wire may function as at least a part of a power transmission path between the working part and the power interface.

The front unit could be configured to include the power interface. In this configuration, however, the weight of the front unit is increased because elements for power supply (e.g., a battery pack, a power cable) are attached to the front unit. This may decrease handleability of the working part, which is located at the front unit. According to the configuration above, the rear unit includes the power interface. Since there is no need to attach the elements for power supply to the front unit, the weight of the front unit can be reduced. This improves handleability of the working part.

### First Embodiment: Working Machine 2

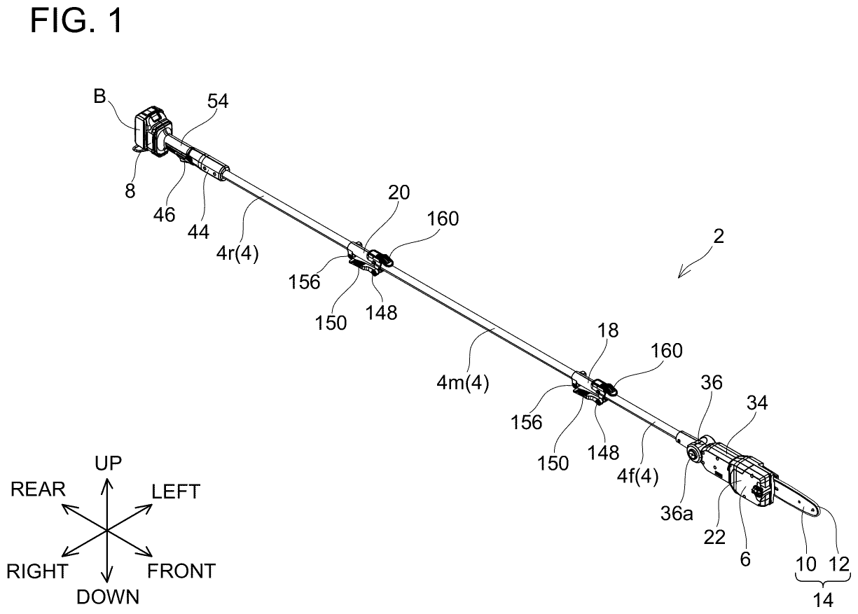

As shown in FIG. 1, a working machine 2 is a pole saw. The pole saw is used to prune high branches. The working machine 2 includes an operation rod 4 extending in a front-rear direction, a front unit 6 disposed at a front end of the operation rod 4, and a rear unit 8 disposed at a rear end of the operation rod 4. A guide bar 10 and a saw chain 12 are detachably attached to the front unit 6. The guide bar 10 is an elongated plate member. The saw chain 12 includes a plurality of cutters connected to each other (not shown) and is attached to the periphery of the guide bar 10. A rechargeable battery pack B is detachably attached to the rear unit 8. The working machine 2 moves the saw chain 12 along the periphery of the guide bar 10 using electric power supplied from the battery pack B to cut branches, etc. In this embodiment, the guide bar 10 and the saw chain 12 may be collectively referred to as “working part 14”.

In the disclosure herein, a direction in which the operation rod 4 extends is termed a front-rear direction, a direction that is perpendicular to the front-rear direction and along a thickness direction of the guide bar 10 is termed a left-right direction, and a direction perpendicular to the front-rear direction and the left-right direction is termed an up-down direction.

The operation rod 4 includes a front rod 4f, an intermediate rod 4m, and a rear rod 4r. Each of the front rod 4f, the intermediate rod 4m, and the rear rod 4r is a tubular member having a substantially circular cross section. The working machine 2 includes a first connecting member 18 that releasably connects the front rod 4f and the intermediate rod 4m to each other and a second connecting member 20 that releasably connects the intermediate rod 4m and the rear rod 4r to each other.

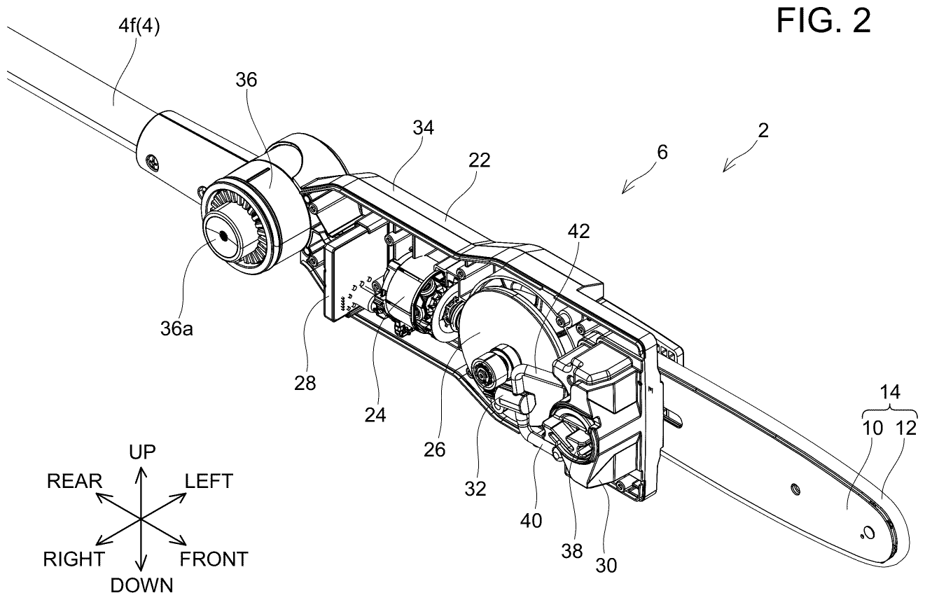

As shown in FIG. 2, the front unit 6 includes a front housing 22, an electric motor 24, a speed reduction mechanism 26, a control unit 28, an oil tank 30, and an oil pump 32. The front housing 22 includes a front housing body 34 and a pivot portion 36. The front housing body 34 houses the electric motor 24, the speed reduction mechanism 26, the control unit 28, the oil tank 30, and the oil pump 32 therein. The front end of the operation rod 4 is attached to the pivot portion 36. The pivot portion 36 retains the front housing body 34 such that the front housing body 34 is pivotable relative to the operation rod 4. Usually, the pivot movement of the front housing body 34 relative to the operation rod 4 is prohibited. The pivot portion 36 includes a manipulatable portion 36a for permitting the pivot movement of the front housing 22 relative to the operation rod 4. A user can change the orientation of the working part 14 relative to the operation rod 4 by pivoting the front housing 22 while pushing in the manipulatable portion 36a.

The electric motor 24 is for example an inner rotor DC brushless motor. The electric motor 24 rotates a motor shaft (not shown) that is rotatably supported by the front housing 22. The motor shaft is connected to a sprocket (not show) via the speed reduction mechanism 26. The saw chain 12 is hung over the sprocket from the guide bar 10. When the electric motor 24 operates, the sprocket rotates and thus the saw chain 12 moves along the periphery of the guide bar 10. That is, the working part 14 operates.

The control unit 28 controls operations of electric components of the working machine 2. The control unit 28 includes for example an inverter circuit including switching elements and a control circuit configured to control the operations of the switching elements. The control unit 28 is configured to adjust the power supplied from the battery pack B and supply it to the electric motor 24 to actuate the electric motor 24.

The oil tank 30 stores a lubricant for lubricating the saw chain 12. A refill opening for resupplying the lubricant (not shown) is formed in the oil tank 30. A cap 38 is detachably attached to the refill opening. The refill opening and the cap 38 are exposed on a right surface of the front housing 22.

The oil pump 32 is connected to the motor shaft (not shown) of the electric motor 24. In conjunction with the rotation of the motor shaft, the oil pump 32 draws the lubricant in the oil tank 30 through an inlet pipe 40 and sends off the lubricant toward the guide bar 10 through an outlet pipe 42.

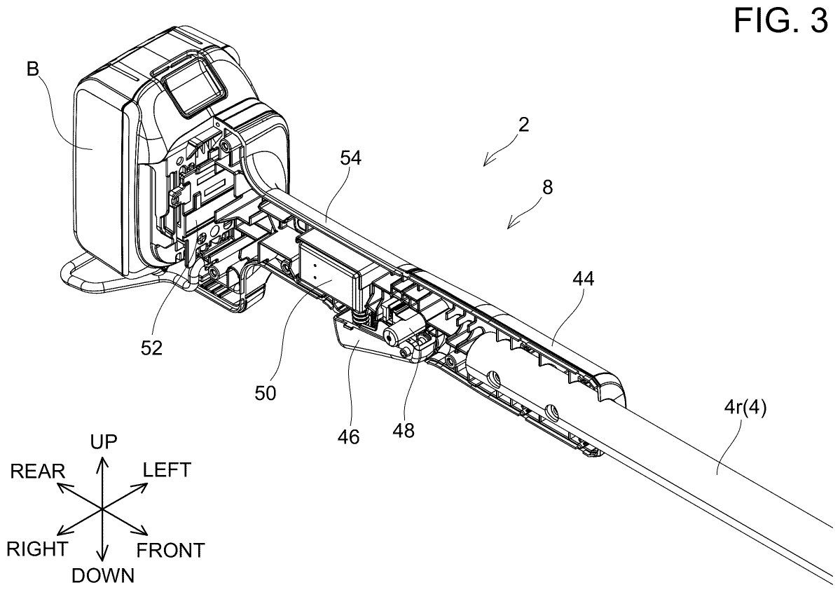

As shown in FIG. 3, the rear unit 8 includes a rear housing 44, a trigger lever 46, a trigger lock 48, a trigger switch 50, and a power interface 52. The rear end of the operation rod 4 is attached to a front portion of the rear housing 44. The rear housing 44 defines a grip 54 for the user to grip. When using the working machine 2, the user grips the grip 54 with one hand and grips the operation rod 4 with the other hand. The above-described battery pack B is detachably attached to a rear portion of the rear housing 44.

The trigger lever 46 is located below the grip 54. The trigger lever 46 is positioned such that it can be manipulated with the index finger of the hand gripping the grip 54. The trigger switch 50 outputs a trigger-on signal to the control unit 28 when the trigger lever 46 is pushed in. The control unit 28 actuates the electric motor 24 while the trigger-on signal is output from the trigger switch 50. To the contrary, the trigger switch 50 outputs a trigger-off signal to the control unit 28 when the trigger lever 46 is not pushed in. The control unit 28 does not actuate the electric motor 24 while the trigger-off signal is output from the trigger switch 50. The trigger lock 48 is positioned such that it can be manipulated with the thumb of the hand gripping the grip 54. The trigger lever 46 is locked when the trigger lock 48 is not pushed in. The trigger lever 46 is unlocked when the trigger lock 48 is pushed in. The user can actuate the working part 14 by pushing the trigger lever 46 in while pushing the trigger lock 48 in.

The power interface 52 is provided for electrically connecting the battery pack B to the working machine 2. The power interface 52 includes an external terminal (not shown) exposed to the outside of the rear housing 44. When the battery pack B is attached to the rear housing 44, the external terminal is connected to a connecting terminal (not shown) of the battery pack B.

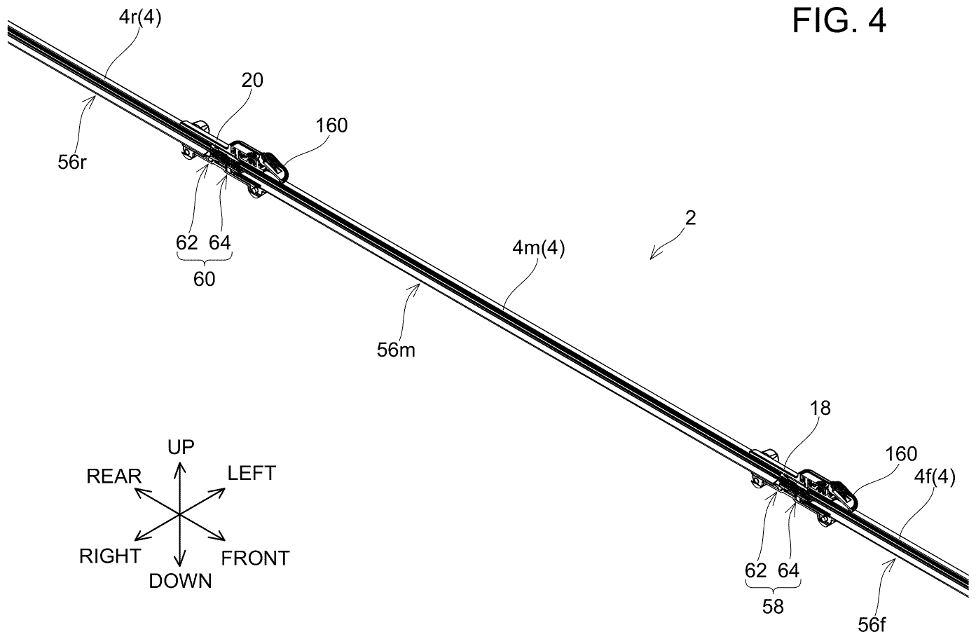

As shown in FIG. 4, the working machine 2 includes a front wire 56f disposed in the interior of the front rod 4f, an intermediate wire 56m disposed in the interior of the intermediate rod 4m, and a rear wire 56r disposed in the interior of the rear rod 4r. The working machine 2 also includes a front connector set 58 for connecting the front wire 56f and the intermediate wire 56m and a rear connector set 60 for connecting the intermediate wire 56m and the rear wire 56r. The front connector set 58 and the rear connector set 60 each include a first connector 62 and a second connector 64.

A front end of the front wire 56f is electrically connected to the front unit 6 (see FIG. 2). The second connector 64 of the front connector set 58 is located at a rear end of the front wire 56f. The first connector 62 of the front connector set 58 is located at a front end of the intermediate wire 56m. The second connector 64 of the rear connector set 60 is located at a rear end of the intermediate wire 56m. The first connector 62 of the rear connector set 60 is located at a front end of the rear wire 56r. A rear end of the rear wire 56r is electrically connected to the rear unit 8 (see FIG. 3). The front wire 56f, the intermediate wire 56m, and the rear wire 56r include various types of wires (e.g., power transmission wires, communication wires). When the front wire 56f, the intermediate wire 56m, and the rear wire 56r are electrically connected to each other, the front unit 6 and the rear unit 8 are electrically connected. This establishes for example a power transmission path between the control unit 28 (see FIG. 2) and the power interface 52 (see FIG. 3) and a communication path between the control unit 28 (see FIG. 2) and the trigger switch 50 (see FIG. 3).

### (Configuration Surrounding First Connector 62)

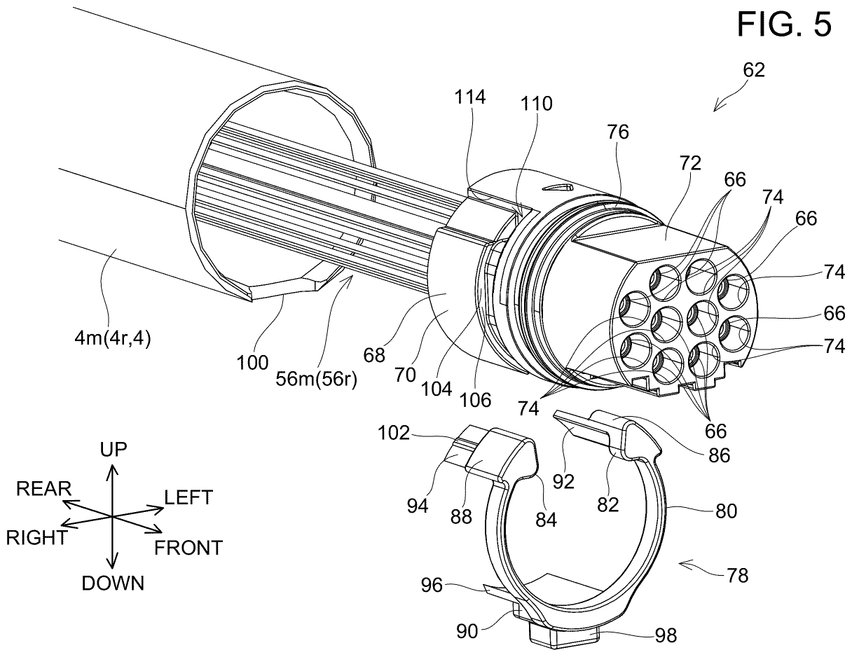

As shown in FIG. 5, each first connector 62 includes a plurality of first terminals 66 and a first connector housing 68. Each of the plurality of first terminals 66 is connected to corresponding one of a plurality of wires which the intermediate wire 56m (the rear wire 56r) includes. The first connector housing 68 holds the plurality of first terminals 66. The first connector housing 68 includes a first connector housing body 70, a mating projection 72 protruding frontward from the first connector housing body 70, and a plurality of terminal holes 74 defined in a front surface of the mating projection 72. Each of the plurality of first terminals 66 is located in corresponding one of the plurality of terminal holes 74. A sealing member 76 is attached to an outer surface of the mating projection 72. The outer diameter of the first connector housing 68 is smaller than the inner diameter of the operation rod 4. Thus, the first connector housing 68 can pass through the interior of the operation rod 4.

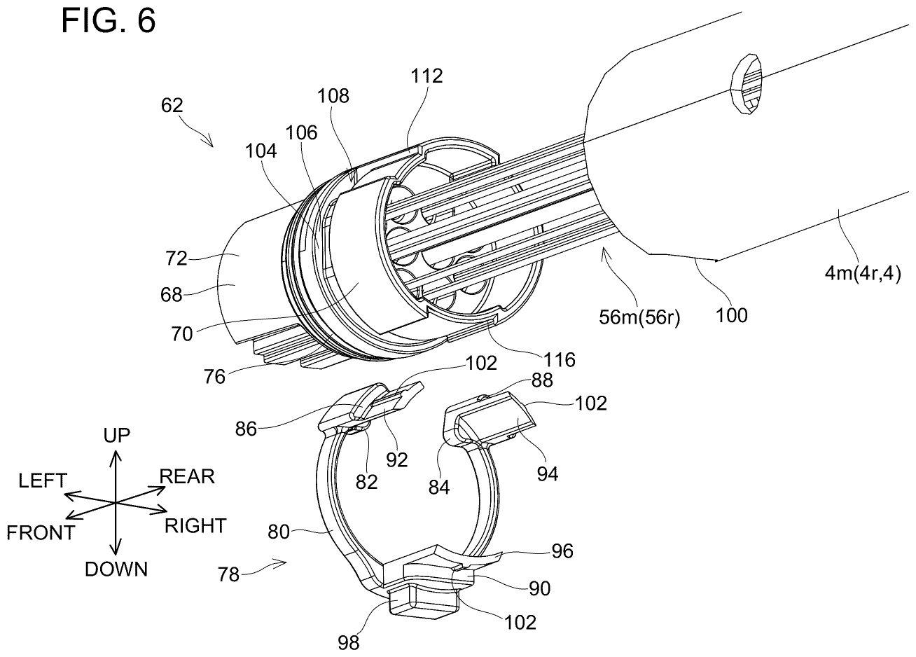

As shown in FIGS. 5 and 6, the working machine 2 includes retaining members 78 each configured to retain the first connector 62 at the front end of the intermediate rod 4m (the rear rod 4r). Each retaining member 78 includes a band portion 80, a first engaging portion 82, a second engaging portion 84, a first stopper portion 86, a second stopper portion 88, a third stopper portion 90, a first press-fit portion 92, a second press-fit portion 94, a third press-fit portion 96, and a guide projection 98. The band portion 80 has an upwardly open C-shape. The first engaging portion 82 is located at one end of the band portion 80 and protrudes radially inward from the band portion 80. The second engaging portion 84 is located at the other end of the band portion 80 and protrudes radially inward from the band portion 80. The first stopper portion 86 is located at the same position as the first engaging portion 82 circumferentially and protrudes radially outward from the band portion 80. The second stopper portion 88 is located at the same position as the second engaging portion 84 circumferentially and protrudes radially outward from the band portion 80. The third stopper portion 90 is located in an intermediate portion of the band portion 80 and protrudes radially outward from the band portion 80. A rear surface of the third stopper portion 90 has a shape that mates with a notch 100 defined in the front end of the intermediate rod 4m (the rear rod 4r). The first press-fit portion 92 is located at the same position as the first stopper portion 86 circumferentially and extends rearward from a rear end of the first stopper portion 86. The second press-fit portion 94 is located at the same position as the second stopper portion 88 circumferentially and extends rearward from a rear end of the second stopper portion 88. The third press-fit portion 96 is located at the same position as the third stopper portion 90 circumferentially and extends rearward from a rear end of the third stopper portion 90. A crush rib 102 extending in the front-rear direction is provided on each of the first press-fit portion 92, the second press-fit portion 94, and the third press-fit portion 96. The guide projection 98 is located at the same position as the third stopper portion 90 circumferentially and protrudes radially outward from an outer surface of the third stopper portion 90.

An attachment groove 104 for attaching the retaining member 78 is defined in the first connector housing body 70. The attachment groove 104 includes a band groove 106 for receiving the band portion 80, a first engagement groove 108 for receiving the first engaging portion 82, a second engagement groove 110 for receiving the second engaging portion 84, a first press-fit groove 112 for receiving the first press-fit portion 92, a second press-fit groove 114 for receiving the second press-fit portion 94, and a third press-fit groove 116 for receiving the third press-fit portion 96.

The retaining member 78 is detachably attached to the first connector housing 68 (specifically, to the attachment groove 104 of the first connector housing 68). Upon attachment of the retaining member 78 to the first connector housing 68, the retaining member 78 is slid upward from below the first connector housing 68, relative to the first connector housing 68. The band portion 80 is thus expanded radially outward by the outer surface of the first connector housing 68 and the first connector housing 68 passes through the opening of the band portion 80. Then, the first engaging portion 82 is engaged with the first engagement groove 108 and the second engaging portion 84 is engaged with the second engagement groove 110, completing the attachment of the retaining member 78 to the first connector housing 68. In this state, the first engaging portion 82 and the second engaging portion 84 are biased radially inward due to the elastic resilience of the band portion 80. Upon removal of the retaining member 78 from the first connector housing 68, the first engaging portion 82 is pulled out from the first engagement groove 108 and the second engaging portion 84 is pulled out from the second engagement groove 110 against the biasing force. Then, the retaining member 78 is pushed downward relative to the first connector housing 68, completing the removal of the retaining member 78 from the first connector housing 68. In the following description, unless otherwise noted, the retaining member 78 is attached to the first connector housing 68. The first connector housing 68 with the retaining member 78 attached thereto cannot pass through the interior of the operation rod 4.

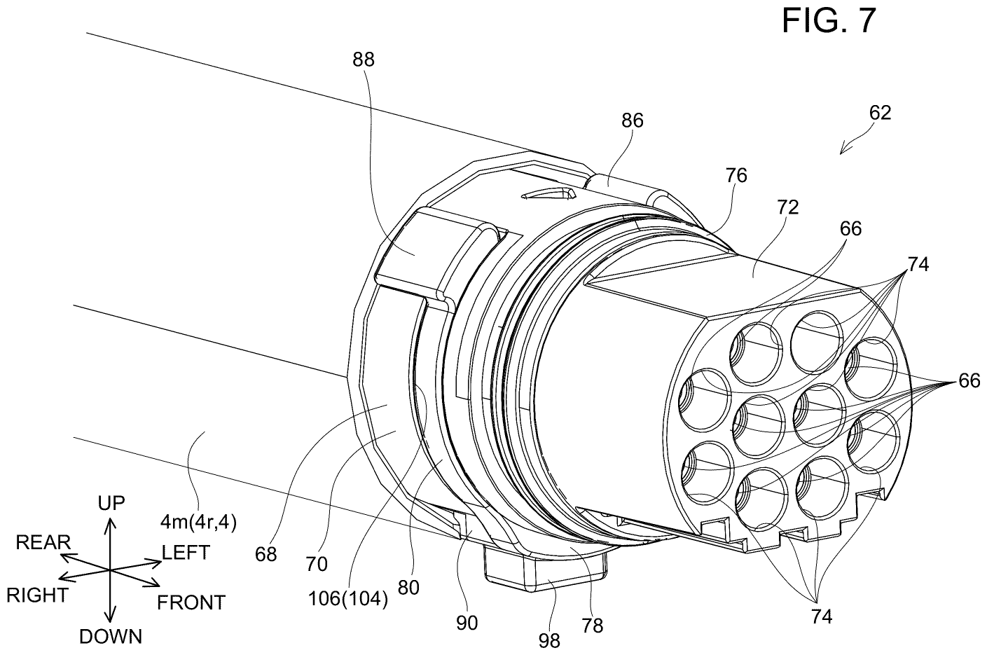

As shown in FIG. 7, the first connector housing 68 is retained at the front end of the intermediate rod 4m (the rear rod 4r) by the first stopper portion 86, the second stopper portion 88, and the third stopper portion 90 each contacting the front end of the intermediate rod 4m (the rear rod 4r). Further, rotation of the first connector housing 68 relative to the intermediate rod 4m (the rear rod 4r) is prohibited by the rear surface of the third stopper portion 90 mating with the notch 100 (see FIG. 5). Moreover, the first press-fit portion 92 (see FIG. 5), the second press-fit portion 94 (see FIG. 5), and the third press-fit portion 96 (see FIG. 5) are each radially pressed between the outer surface of the first connector housing 68 and the inner surface of the intermediate rod 4m (the rear rod 4r). This suppressed the first connector housing 68 from playing against the intermediate rod 4m (the rear rod 4r).

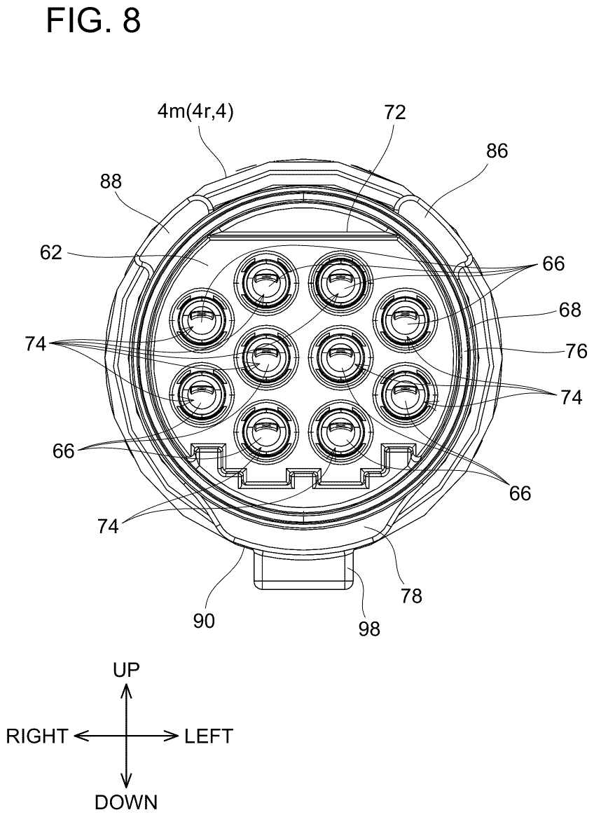

As shown in FIG. 8, the first stopper portion 86, the second stopper portion 88, and the third stopper portion 90 are circumferentially arranged such that they are substantially equally spaced from each other. Further, the outer surfaces of the first stopper portion 86, the second stopper portion 88, and the third stopper portion 90 are located outward of the outer surface of the first connector housing 68 and located inward of the outer surface of the intermediate rod 4m (the rear rod 4r). Moreover, the outer surface of the guide projection 98 is located outward of the outer surface of the intermediate rod 4m (the rear rod 4r). Furthermore, the outer surface of the band portion 80 shown in FIG. 7 is flush with the outer surface of the first connector housing 68 or is located inward of the outer surface of the first connector housing 68.

### (Configuration Surrounding Second Connector 64)

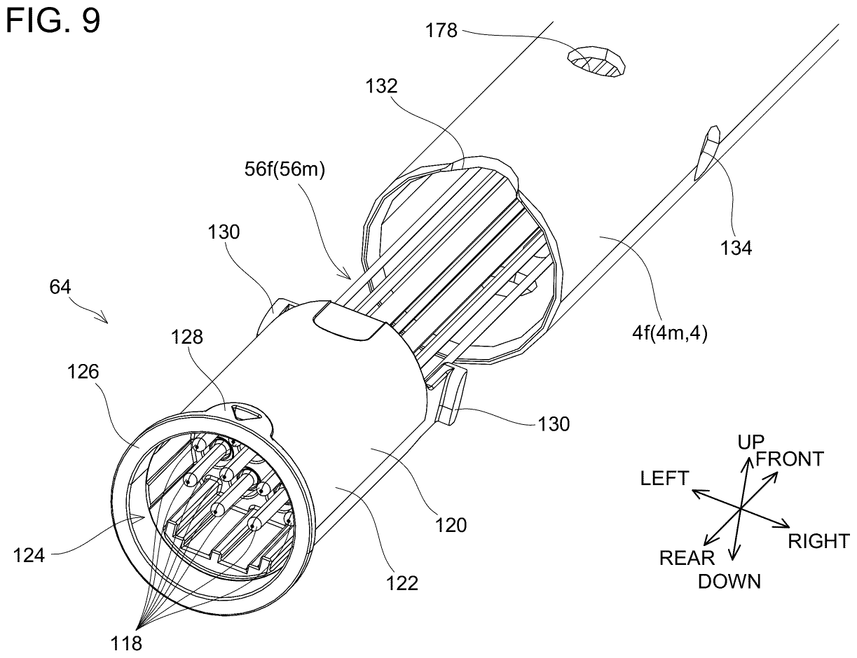

As shown in FIG. 9, each second connector 64 includes a plurality of second terminals 118 and a second connector housing 120. Each of the plurality of second terminals 118 is connected to corresponding one of a plurality of wires which the front wire 56f (the intermediate wire 56m) includes. The second terminals 118 are respectively positioned to correspond to the first terminals 66 and the terminal holes 74 of the first connector 62 shown in FIG. 5. As shown in FIG. 9, the second connector housing 120 holds the plurality of second terminals 118. The second connector housing 120 includes a second connector housing body 122, a mating recess 124, a flange portion 126, an alignment portion 128, and a plurality of engagement claws 130. The mating recess 124 is formed by recessing a rear portion of the second connector housing body 122. The flange portion 126 extends outward from a rear end of the second connector housing body 122. The alignment portion 128 has a shape that mates with a notch 132 defined in the rear end of the front rod 4f (the intermediate rod 4m). The engagement claws 130 are located on the second connector housing body 122, one on the right side and the other on the left side.

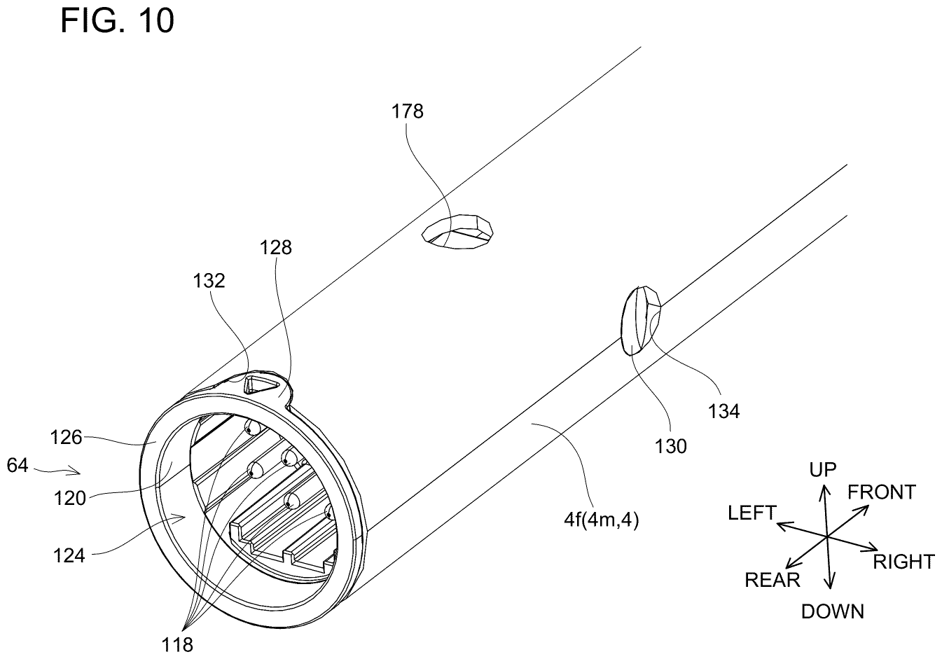

As shown in FIG. 10, each of the engagement claws 130 engages with corresponding one of a plurality of engagement holes 134 (depiction partially omitted) defined in the front rod 4f (the intermediate rod 4m). Further, a front surface of the flange portion 126 contacts the rear end of the front rod 4f (the intermediate rod 4m). Moreover, the alignment portion 128 mates with the notch 132. In this way, the second connector housing 120 is retained at the rear end of the front rod 4f (the intermediate rod 4m) in a predetermined orientation. Unlike the first connector housing 68, the second connector housing 120 cannot pass through the interior of the operation rod 4.

### (Configuration of First Connecting Member 18)

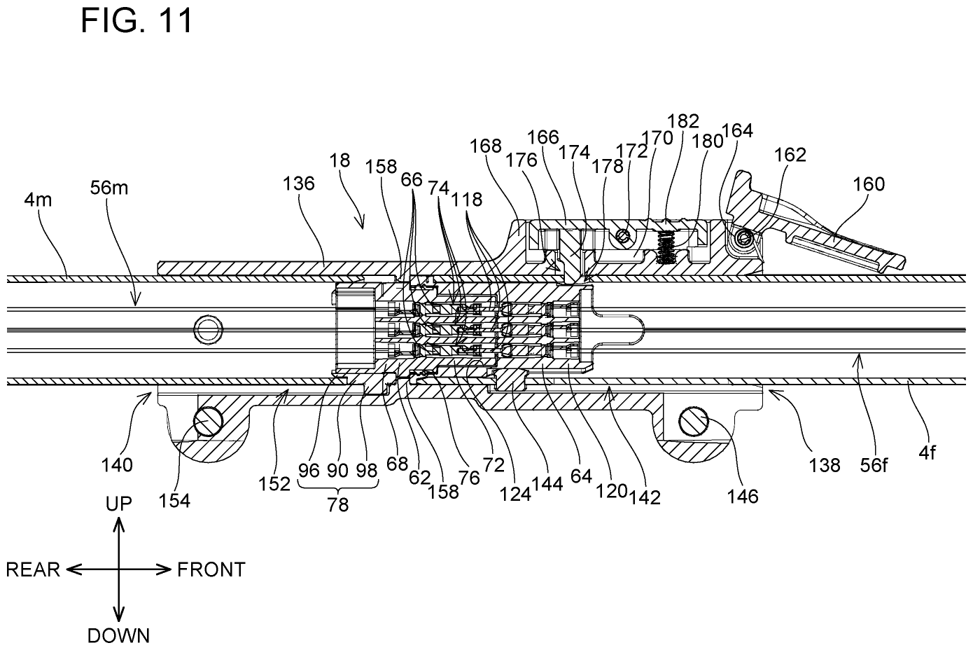

As shown in FIG. 11, the first connecting member 18 includes a cylindrical portion 136 extending in the front-rear direction. The rear end of the front rod 4f is inserted into a front opening 138 of the cylindrical portion 136. The front end of the intermediate rod 4m is inserted into a rear opening 140 of the cylindrical portion 136. In the interior of the cylindrical portion 136, the first connector 62 retained at the front end of the intermediate rod 4m and the second connector 64 retained at the rear end of the front rod 4f are connected to each other. Specifically, the mating projection 72 mates with the mating recess 124 and the second terminals 118 are inserted into the plurality of terminal holes 74 and connected to the first terminals 66. Thus, the front wire 56f and the intermediate wire 56m are electrically connected to each other. Further, the sealing member 76 on the mating projection 72 seals between the outer surface of the mating projection 72 and the inner surface of the mating recess 124.

A front guide groove 142 is defined in the cylindrical portion 136. The front guide groove 142 is formed by recessing the inner surface of the cylindrical portion 136 radially outward and extends rearward from a front end of the cylindrical portion 136. A first projection pin 144 located in a lower portion of the front rod 4f is slidably received by the front guide groove 142 in the front-rear direction. This prevents the first connecting member 18 and the front rod 4f from rotating relative to each other. Further, a slit (not shown) extending rearward from the front end of the cylindrical portion 136 is defined in the bottom of the front guide groove 142. In this embodiment, the slit is closed by fastening a bolt 146 and a nut 148 (see FIG. 1) and the diameter of a front portion of the cylindrical portion 136 is thereby reduced, which fixes the first connecting member 18 and the front rod 4f to each other. Further, a lever 150 (see FIG. 1) configured to be manipulated by the user is located on the nut 148 which fixes the front rod 4f. The user can tighten and loosen the nut 148 by manipulating the lever 150 even when the user does not have a tool such as a wrench. The user can separate the first connecting member 18 from the front rod 4f by loosening the nut 148 and pulling the front rod 4f out of the cylindrical portion 136. When the first connecting member 18 I separated from the front rod 4f, the connection between the first connector 62 and the second connector 64 is released.

A rear guide groove 152 is defined in the cylindrical portion 136. The rear guide groove 152 is formed by recessing the inner surface of the cylindrical portion 136 radially outward and extends rearward from a rear ed of the cylindrical portion 136. The guide projection 98 of the retaining member 78 is slidably received by the rear guide groove 152 in the front-rear direction. This prevents the first connecting member 18 and the retaining member 78 (thus the first connector 62 and the intermediate rod 4m) from rotating relative to each other. Further, a slit (not shown) extending frontward from the rear end of the cylindrical portion 136 is defined in the bottom of the rear guide groove 152. In this embodiment, the first connecting member 18 and the intermediate rod 4m are fixed to each other by the slit being closed by fastening a bolt 154 and a nut 156 (see FIG. 1) and the diameter of a rear portion of the cylindrical portion 136 being thereby reduced. A member corresponding to the above-described lever 150 (see FIG. 1) is not attached to the nut 156 which fixes the intermediate rod 4m. Usually, the first connecting member 18 is not expected to be separated from the intermediate rod 4m by the user.

The cylindrical portion 136 includes an inward flange 158. The inward flange 158 is located rearward of a rear end of the front guide groove 142 and frontward of a front end of the rear guide groove 152. A rear surface of the inward flange 158 contacts the first stopper portion 86 (see FIG. 7), the second stopper portion 88 (see FIG. 7), and the third stopper portion 90 from the front. Thus, the first stopper portion 86, the second stopper portion 88, and the third stopper portion 90 are interposed between the first connecting member 18 and the intermediate rod 4m.

The first connecting member 18 includes a movable lid 160. The movable lid 160 is swingably supported by the cylindrical portion 136 via a shaft 162. The movable lid 160 is movable between an open position at which the front opening 138 of the cylindrical portion 136 is open to the outside and a closed position at which the front opening 138 of the cylindrical portion 136 is closed by the movable lid 160. A torsion spring 164 is attached to the shaft 162. The torsion spring 164 biases the movable lid 160 toward the closed position. When the front rod 4f is separated from the first connecting member 18, the movable lid 160 moves from the open position to the closed position and stays at the closed position, and therefore entry of foreign matters into the interior of the intermediate rod 4m is prevented.

The first connecting member 18 includes a lock member 166. The lock member 166 locks the front rod 4f to the first connecting member 18. The lock member 166 is located outside the cylindrical portion 136. A recess 170 is defined in the outer surface of the cylindrical portion 136 and is surrounded by an annularly extending wall 168. The lock member 166 is located in the recess 170. The lock member 166 is swingably supported by the cylindrical portion 136 via a shaft 172. The lock member 166 includes a projection 174 in its portion rearward of the shaft 172. The projection 174 protrudes into the cylindrical portion 136 through a first through hole 176 defined in the first connecting member 18. Further, a second through hole 178 is defined in the outer surface of the front rod 4f, into which the projection 174 is inserted. The front rod 4f is locked to the first connecting member 18 by the projection 174 of the lock member 166 being inserted into the second through hole 178. There is a coil spring 180 between the lock member 166 and the first connecting member 18. The coil spring 180 biases a portion of the lock member 166 that is frontward of the shaft 172 upward. The projection 174 is thus pressed downward. Further, the lock member 166 includes a user-manipulatable release portion 182 in the portion frontward of the shaft 172. When the release portion 182 is pushed against the biasing force of the coil spring 180, the projection 174 is removed out of the second through hole 178. Thus, the lock by the lock member 166 is released.

### (Configuration of Second Connecting Member 20)

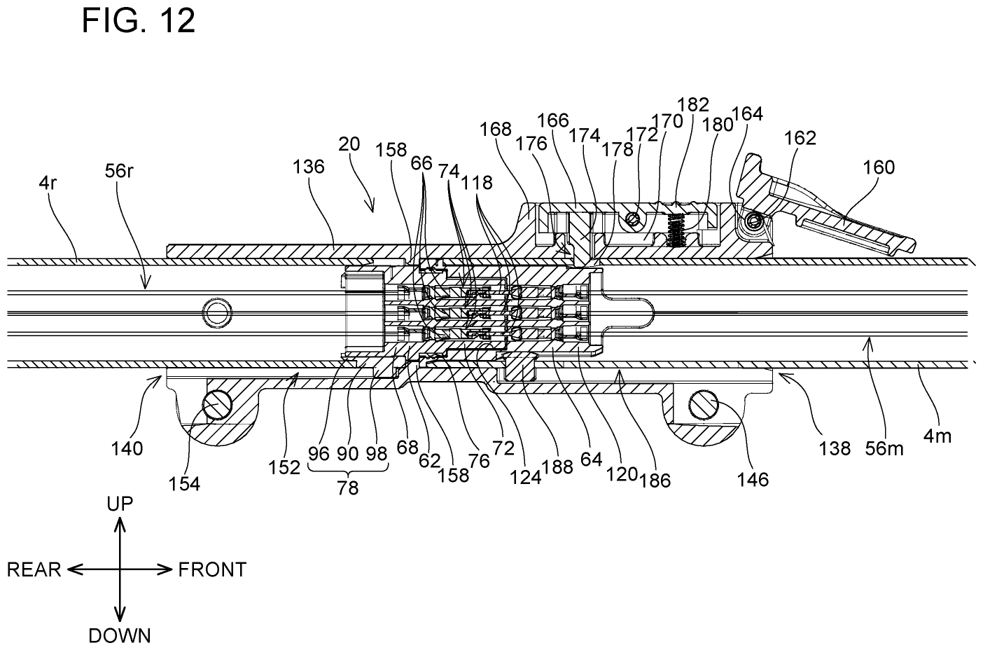

As shown in FIG. 12, the second connecting member 20 includes substantially the same components as those of the first connecting member 18. In the following description, only differences from the first connecting member 18 are described. Components of the second connecting member 20 that are the same as those of the first connecting member 18 are labeled with the same reference signs used for the first connecting member 18 and description for them is omitted.

The rear end of the intermediate rod 4m is inserted into a front opening 138 of a cylindrical portion 136 of the second connecting member 20. The front ed of the rear rod 4r is inserted into a rear opening 140 of the cylindrical portion 136. In the interior of the cylindrical portion 136, the first connector 62 retained at the front end of the rear rod 4r and the second connector 64 retained at the rear end of the intermediate rod 4m are connected to each other. Thus, the rear wire 56r and the intermediate wire 56m are electrically connected to each other.

A front guide groove 186 is defined in the cylindrical portion 136 of the second connecting member 20, and the depth of the front guide groove 186 is different from that of the front guide groove 142 (see FIG. 11) of the first connecting member 18. For example, the depth of the front guide groove 186 is larger than the depth of the front guide groove 142. A second projection pin 188 located in a lower portion of the intermediate rod 4m is slidably received by the front guide groove 186 in the front-rear direction. This prevents the second connecting member 20 and the intermediate rod 4m from rotating relative to each other. The height of the second projection pin 188 from the outer surface of the intermediate rod 4m is larger than the height of the first projection pin 144 (see FIG. 11) from the outer surface of the front rod 4f (see FIG. 11).

### (Mechanism for Preventing Connection of Multiple Intermediate Rods 4m)

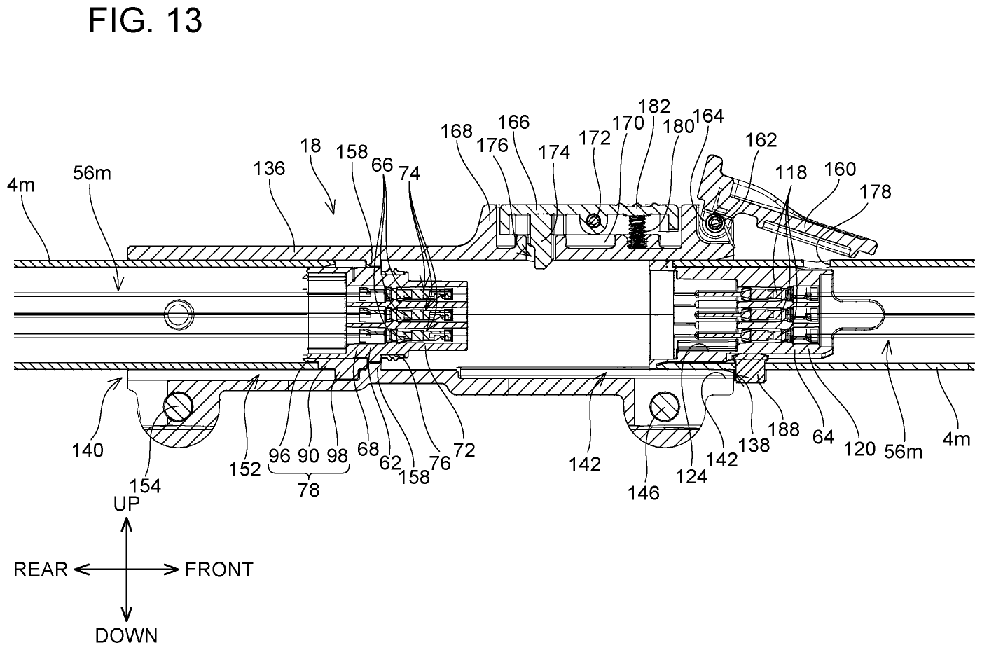

As shown in FIG. 13, the user may prepare a plurality of intermediate rods 4m and attempt to connect them to each other. In this case, the rear end of an intermediate rod 4m is inserted into the front opening 138 of the cylindrical portion 136 of the first connecting member 18 located at the front end of another intermediate rod 4m. However, in this embodiment, the second projection pin 188 attached to the intermediate rod 4m is configured not to pass through the front opening 138. Specifically, the height of the second projection pin 188 attached to the intermediate rod 4m is larger than the depth of the front guide groove 142 of the first connecting member 18. This prevents an intermediate rod 4m from being inserted to an appropriate position in the cylindrical portion 136 of the first connecting member 18 located at the front end of another intermediate rod 4m, and thus prevents multiple intermediate rods 4m from being connected to each other. Herein, “appropriate position” means for example the position where the first connector 62 and the second connector 64 are connected to each other.

### (Attachment of Front Rod 4f to Front Unit 6)

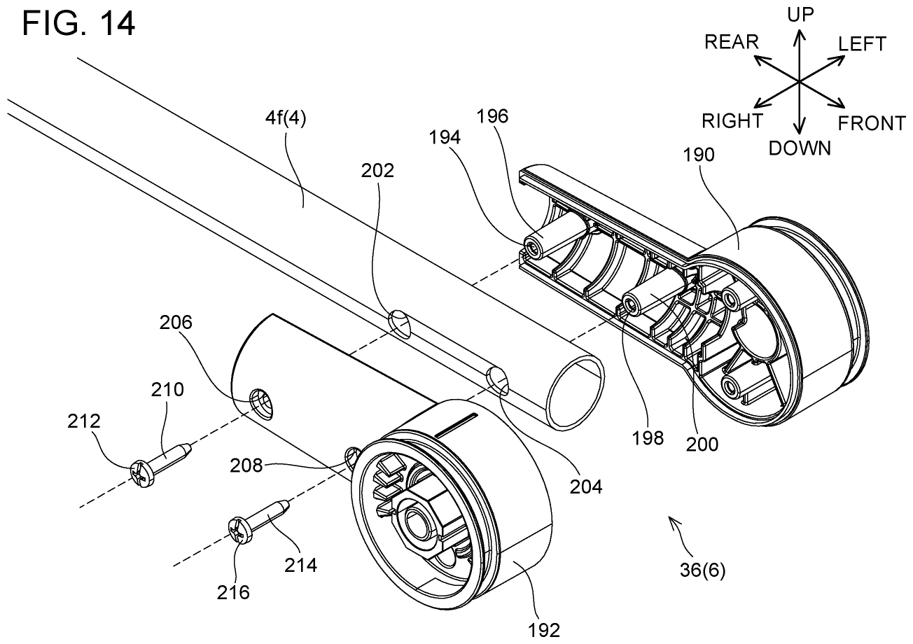

As shown in FIG. 14, the pivot portion 36 of the front unit 6 includes a left member 190 and a right member 192. The left member 190 includes a first boss 196 with an internal thread 194 and a second boss 200 with an internal thread 198. A first insertion hole 202 into which the first boss 196 is inserted from the left and a second insertion hole 204 into which the second boss 200 is inserted from the left are defined in the front rod 4f. A first attachment hole 206 positioned corresponding to the first insertion hole 202 and a second attachment hole 208 positioned corresponding to the second insertion hole 204 are defined in the right member 192. A first screw member 212 with an external thread 210 corresponding to the internal thread 194 is attached to the first attachment hole 206. The external thread 210 of the first screw member 212 is inserted into the first insertion hole 202 from the right and is screw-fitted with the internal thread 194 of the first boss 196. Further, a second screw member 216 with an external thread 214 corresponding to the internal thread 198 is attached to the second attachment hole 208. The external thread 214 of the second screw member 216 are inserted into the second insertion hole 204 from the right and is screw-fitted with the internal thread 198 of the second boss 200.

In order to remove the front rod 4f from the front unit 6, the first screw member 212 and the second screw member 216 need to be removed first with a tool (e.g., a screwdriver). Then, the pivot portion 36 needs to be disassembled into the left and right members to remove the first boss 196 out of the first insertion hole 202 and the second boss 200 out of the second insertion hole 204. Thus, with the above-described attachment, the front rod 4f is attached to the front unit 6 in a difficult-to-remove manner.

### (Attachment of Rear Rod 4r to Rear Unit 8)

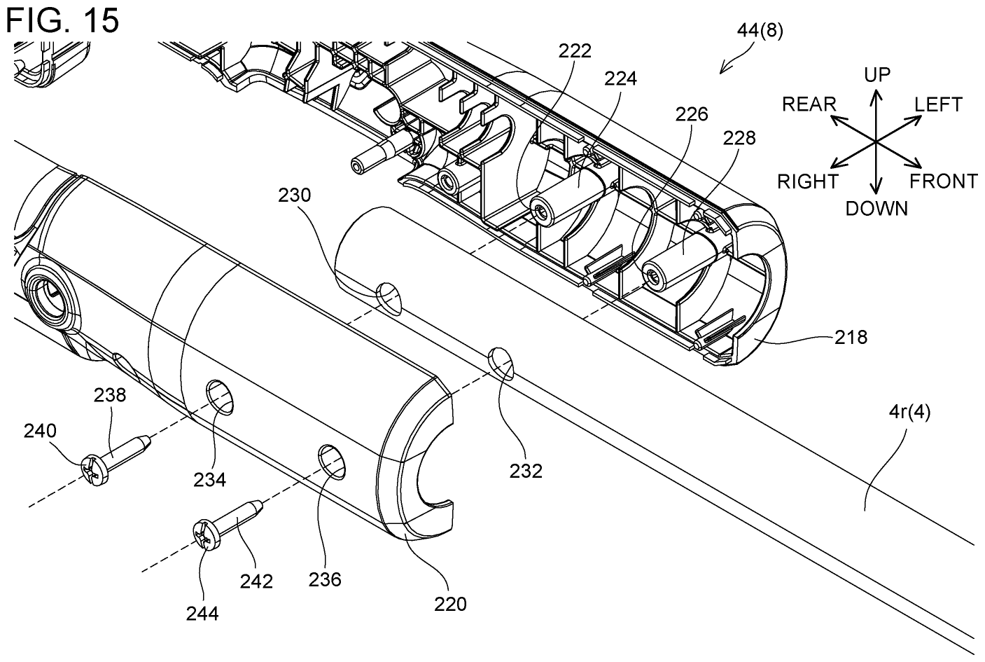

As shown in FIG. 15, the rear housing 44 of the rear unit 8 includes a left member 218 and a right member 220. The left member 218 includes a third boss 224 with an internal thread 222 and a fourth boss 228 with an internal thread 226. A third insertion hole 230 into which the third boss 224 is inserted from the left and a fourth insertion hole 232 into which the fourth boss 228 is inserted from the left are defined in the rear rod 4r. A third attachment hole 234 positioned corresponding to the third insertion hole 230 and a fourth attachment hole 236 positioned corresponding to the fourth insertion hole 232 are defined in the right member 220. A third screw member 240 with an external thread 238 corresponding to the internal thread 222 is attached to the third attachment hole 234. The external thread 238 of the third screw member 240 are inserted into the third insertion hole 230 from the right and are screw-fitted with the internal thread 222 of the third boss 224. Further, a fourth screw member 244 with an external thread 242 corresponding to the internal thread 226 is attached to the fourth attachment hole 236. The external thread 242 of the fourth screw member 244 are inserted into the fourth insertion hole 232 from the right and are screw-fitted with the internal thread 226 of the fourth boss 228.

In order to remove the rear rod 4r from the rear unit 8, the third screw member 240 and the fourth screw member 244 need to be removed first with a tool (e.g., a screwdriver). Then, the rear housing 44 needs to be disassembled into the left and right members to remove the third boss 224 out of the third insertion hole 230 and the fourth boss 228 out of the fourth insertion hole 232. Thus, with the above-described attachment, the rear rod 4r is attached to the rear unit 8 in a difficult-to-remove manner.

### Second Embodiment: Working Machine 302

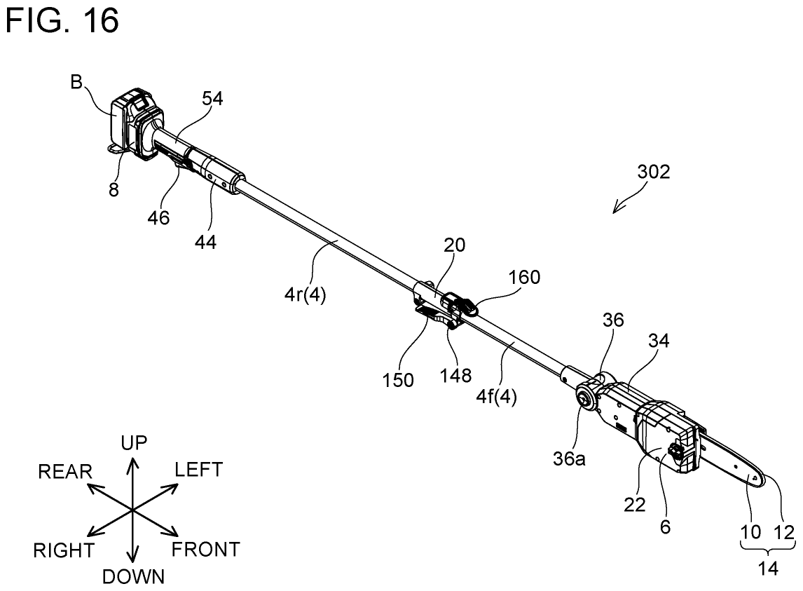

As shown in FIG. 16, a working machine 302 is different from the working machine 2 according to the first embodiment in that it does not include the intermediate rod 4m and the first connecting member 18. In this embodiment, the front rod 4f and the rear rod 4r are connected to each other via the second connecting member 20. When the front rod 4f and the rear rod 4r are connected to each other, the second connector 64 (see FIG. 10) located at the rear end of the front rod 4f and the first connector 62 (see FIG. 7) located at the front end of the rear rod 4r are connected to each other. Thus, the front wire 56f (see FIG. 4) and the rear wire 56r (see FIG. 4) are electrically connected to each other.

### Third Embodiment; Working Machine 402

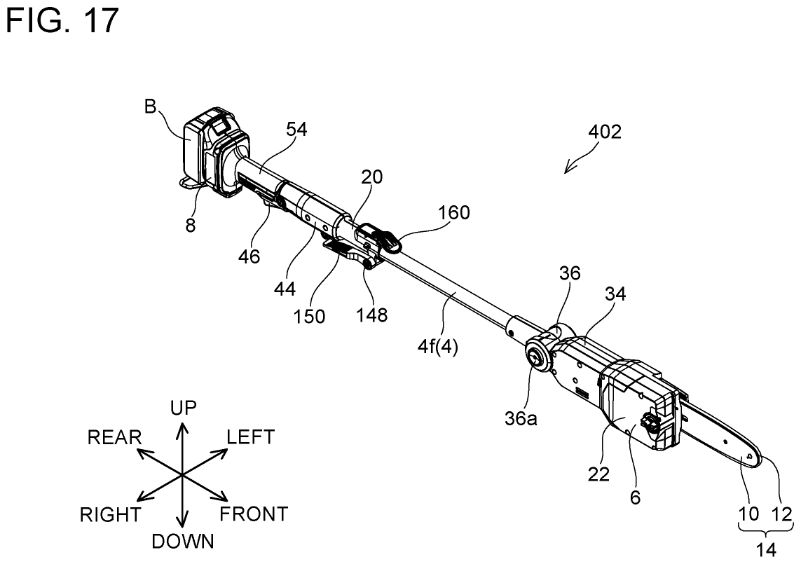

As shown in FIG. 17, a working machine 402 is different from the working machine 302 according to the second embodiment in that it does not include the rear rod 4r. In this embodiment, the second connecting member 20 is fixed to the rear housing 44. As with the second embodiment, the front rod 4f is connected to the front portion of the second connecting member 20. In this embodiment, the notch 100 (see FIG. 5), instead of the notch 132 (see FIG. 9), is defined in the rear end of the front rod 4f, and the first connector 62 (see FIG. 7), instead of the second connector 64 (see FIG. 10), is located at the rear end of the front rod 4f. This first connector 62 is electrically connected to the front wire 56f. Further, in this embodiment, the second connecting member 20 includes a configuration for receiving the second connector 64 (e.g., the notch 132, the plurality of engagement holes 134) and the second connector 64 is located at the second connecting member 20. This second connector 64 is electrically connected to the rear unit 8. When the front rod 4f is inserted into the front opening 138 of the second connecting member 20, the first connector 62 at the rear end of the front rod 4f and the second connector 64 at the second connecting member 20 are connected to each other. Thus, the front wire 56f and the rear unit 8 are electrically connected to each other.

### Fourth Embodiment; Working Machine 502

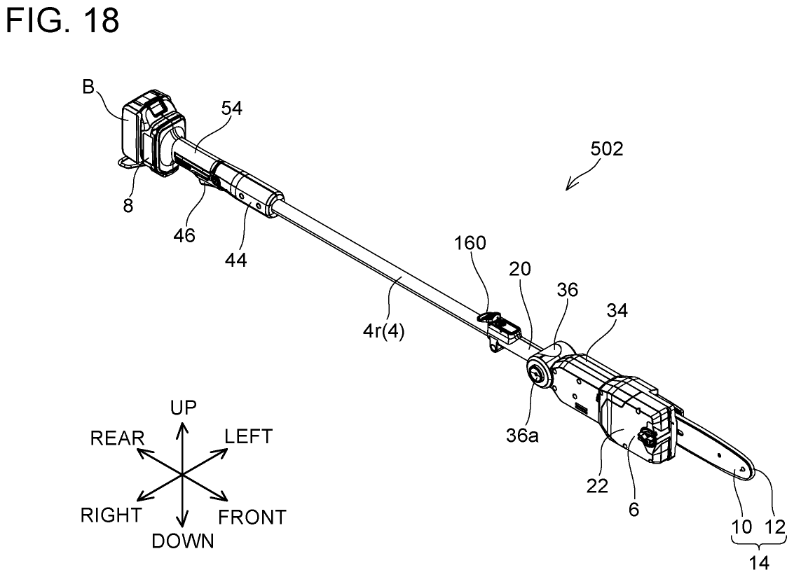

As shown in FIG. 18, a working machine 502 is different from the working machine 302 according to the second embodiment in that it does not include the front rod 4f. In this embodiment, the second connecting member 20 is fixed to the front housing 22 in the opposite orientation in the front-rear direction to its orientation in the second embodiment. The rear rod 4r is connected to the rear portion of the second connecting member 20. As with the second embodiment, the first connector 62 (see FIG. 7) is located at the front end of the rear rod 4r. Further, the second connector 64 (see FIG. 10) is located in the interior of the second connecting member 20. This second connector 64 is electrically connected to the front unit 6. When the rear rod 4r is connected to the second connecting member 20, the first connector 62 and the second connector 64 are connected to each other and thus the rear wire 56r (see FIG. 4) and the front unit 6 are electrically connected to each other.

### (Variants)

The working machine 2, 302, 402, 502 may be for example a mower, a pruning shears for high branches, a pole hedge trimmer, a pole clipper, a lighting device, or a rebar tying machine. Thus, the working part 14 may be replaced with a rotary blade, shears, a hedge trimmer blade, a clipper blade, a light source (e.g., LED, fluorescent), or a rebar tying machine. The rebar tying machine herein may mean a device configured to perform a series of operations of: winding a wire around an intersection of multiple rebars, twisting the wire, and cutting the wire.

A handle unit configured to be gripped by the user may be provided on an intermediate portion of the operation rod 4. The handle unit may include a user-manipulatable button (e.g., a power button). In this case, the button and the control unit 28 may be electrically connected to each other by a wire extending through the interior of the operation rod 4.

The second connector 64 may be configured to pass through the interior of the operation rod 4. In this case, the working machine 2, 302, 402 may further include a member configured to retain the second connector 64 at the rear end of the front rod 4f (the intermediate rod 4m). This member may have a configuration similar to that of the retaining member 78.

The first connector 62 may be fixed to the operation rod 4 with a screw instead of being retained in the operation rod 4 by the retaining member 78. Alternatively, the first connector 62 may be bonded to the operation rod 4 via an adhesive.

In the first embodiment, the position of the first connector 62 of the front connector set 58 and the position of the second connector 64 of the front connector set 58 may be reversed. That is, the first connector 62 of the front connector set 58 may be retained at the rear end of the front rod 4f, and the second connector 64 of the front connector set 58 may be retained at the front end of the intermediate rod 4m.

In the first embodiment, the position of the first connector 62 of the rear connector set 60 and the position of the second connector 64 of the rear connector set 60 may be reversed. That is, the first connector 62 of the rear connector set 60 may be retained at the rear end of the intermediate rod 4m, and the second connector 64 of the rear connector set 60 may be retained at the front end of the rear rod 4r.

In the second embodiment, the position of the first connector 62 and the position of the second connector 64 may be reversed. That is, the first connector 62 may be retained at the rear end of the front rod 4f, and the second connector 64 may be retained at the front end of the rear rod 4r.

The operation rod 4 may be a tubular member having a polygonal cross section.

The retaining member 78 may not include one of the first stopper portion 86, the second stopper portion 88, and the third stopper portion 90. Alternatively, the retaining member 78 may not include two of the first stopper portion 86, the second stopper portion 88, and the third stopper portion 90. Alternatively, the retaining member 78 may include an additional stopper portion in addition to the first stopper portion 86, the second stopper portion 88, and the third stopper portion 90.

The outer surface of at least one of the first stopper portion 86, the second stopper portion 88, and the third stopper portion 90 may be located outward of the outer surface of the operation rod 4.

The retaining member 78 may not include at least one of the first press-fit portion 92, the second press-fit portion 94, and the third press-fit portion 96.

The notch 100 may not be defined in the front end of the intermediate rod 4m (the rear rod 4r).

The retaining member 78 may not include the guide projection 98. In this case, the rear guide groove 152 may not be defined in the cylindrical portion 136 of the first connecting member 18 (or the second connecting member 20).

The cylindrical portion 136 of the first connecting member 18 (or the second connecting member 20) may not include the inward flange 158.

The working machine 2, 302, 402, 502 may include a fastener (e.g., a pin) for attaching the retaining member 78 to the first connector housing 68.

The front rod 4f (or the intermediate rod 4m, the rear rod 4r) and the intermediate rod 4m (or the rear rod 4r, the front rod 4f) may be connected to each other in a different manner or by a different means from those described in connection with the above embodiments. For example, an external thread at an end of the front rod 4f (or the intermediate rod 4m, the rear rod 4r) may be screw-fitted with an internal thread at an end of the intermediate rod 4m (or the rear rod 4r, the front rod 4f) to connect them to each other.

Instead of the battery pack B, a power cable for connection to an external power supply may be attached to the rear unit 8. In this case, the power interface 52 may be configured to electrically connect to the power cable.

### (Corresponding Relationships)

In one or more embodiments, a working machine 2, 302, 402, 502 (an example of working machine) comprises a rear rod 4r (or a front rod 4f, an intermediate rod 4m) (an example of first operation rod) extending in a front-rear direction, a front unit 6 disposed frontward of the rear rod 4r (or the front rod 4f, the intermediate rod 4m) and comprising a working part 14, a rear unit 8 disposed rearward of the rear rod 4r (or the front rod 4f, the intermediate rod 4m), a rear wire 56r (or a front wire 56f, an intermediate wire 56m) (an example of first wire) disposed in an interior of the rear rod 4r (or the front rod 4f, the intermediate rod 4m), a plurality of first terminals 66 electrically connected to the rear wire 56r (or the front wire 56f, the intermediate wire 56m), a first connector housing 68 holding the plurality of first terminals 66 and configured to pass through the interior of the rear rod 4r (or the front rod 4f, the intermediate rod 4m) in the front-rear direction, a retaining member 78 (an example of retainer) configured to retain the first connector housing 68 at one end of the rear rod 4r (or the front rod 4f, the intermediate rod 4m), a plurality of second terminals 118, and a second connector housing 120 holding the plurality of second terminals 118 and configured to be detachably attached to the first connector housing 68. The first terminals 66 and the second terminals 118 are electrically connected to each other by the first connector housing 68 and the second connector housing 120 being attached to each other.

If the first connector housing 68 is not configured to pass through the interior of the rear rod 4r (or the front rod 4f, the intermediate rod 4m), it is expected that it would take time and effort to release the connection between the first connector housing 68 and the rear wire 56r (or the front wire 56f, the intermediate wire 56m) in the connector assembling operation, or to disassemble the rear rod 4r (or the front rod 4f, the intermediate rod 4m). According to the above configuration, the first connector housing 68 is configured to pass through the interior of the rear rod 4r (or the front rod 4f, the intermediate rod 4m). Therefore, the time and effort to release the connection between the first connector housing 68 and the rear wire 56r (or the front wire 56f, the intermediate wire 56m) or to disassemble the rear rod 4r (or the front rod 4f, the intermediate rod 4m) can be saved during the connector assembling operation. Thus, the time and effort to perform the connector assembling operation can be reduced.

In one or more embodiments, the retaining member 78 is configured to be detachably attached to the first connector housing 68. The retaining member 78 is configured to retain the first connector housing 68 at the one end of the rear rod 4r (or the front rod 4f, the intermediate rod 4m).

For example, bonding the first connector housing 68 to the rear rod 4r (or the front rod 4f, the intermediate rod 4m) via an adhesive could be considered. However, if the first connector housing 68 is bonded to the rear rod 4r (or the front rod 4f, the intermediate rod 4m) in that way, it is difficult to detach the first connector housing 68 from the rear rod 4r (or the front rod 4f, the intermediate rod 4m). Thus, it is difficult to redo the connector assembling operation. This may be a burden on a manufacturer of the working machine 2, 302, 402, 502. According to the configuration above, the retaining member 78, which retains the first connector housing 68 at the rear rod 4r (or the front rod 4f, the intermediate rod 4m), is configured to be detachably attached to the first connector housing 68. Therefore, the connector assembling operation can be easily redone after it has once completed. Thus, the burden on the manufacturer of the working machine 2, 302, 402, 502 is reduced.

In one or more embodiments, the retaining member 78 comprises a first stopper portion 86, a second stopper portion 88, and a third stopper portion 90 that protrude outward beyond an outer surface of the first connector housing 68 when the retaining member 78 is attached to the first connector housing 68. The first connector housing 68 is retained at the one end of the rear rod 4r (or the front rod 4f, the intermediate rod 4m) by the first stopper portion 86, the second stopper portion 88, and the third stopper portion 90 contacting the rear rod 4r (or the front rod 4f, the intermediate rod 4m) in the front-rear direction.

The configuration above allows the first connector housing 68 to be retained with the rear rod 4r (or the front rod 4f, the intermediate rod 4m) in a relatively simple manner.

In one or more embodiments, a stopper portion comprises a first stopper portion 86 and a second stopper portion 88 circumferentially offset from the first stopper portion 86.

If the retaining member 78 contacts the end of the rear rod 4r (or the front rod 4f, the intermediate rod 4m) at only one point, the position of the first connector housing 68 relative to the end of the rear rod 4r (or the front rod 4f, the intermediate rod 4m) may not be stabilized. According to the configuration above, the retaining member 78 contacts the end of the rear rod 4r (or the front rod 4f, the intermediate rod 4m) at two or more points. Therefore, the position of the first connector housing 68 relative to the end of the rear rod 4r (or the front rod 4f, the intermediate rod 4m) can be stabilized.

In one or more embodiments, the stopper portion further comprises a third stopper portion 90 circumferentially offset from each of the first stopper portion 86 and the second stopper portion 88.

According to the configuration above, the retaining member 78 contacts the end of the rear rod 4r (or the front rod 4f, the intermediate rod 4m) at three or more points. Therefore, the position of the first connector housing 68 relative to the end of the rear rod 4r (or the front rod 4f, the intermediate rod 4m) can be further stabilized.

In one or more embodiments, outer surfaces of the first stopper portion 86, the second stopper portion 88, and the third stopper portion 90 are located inward of an outer surface of the rear rod 4r (or the front rod 4f, the intermediate rod 4m) as viewed along the front-rear direction.

If the outer surfaces of the first stopper portion 86, the second stopper portion 88, and the third stopper portion 90 are located outward of the outer surface of the rear rod 4r (or the front rod 4f, the intermediate rod 4m), problems may be thereby caused. For example, when a first connecting member 18 (or a second connecting member 20) (an example of a member) is attached to the rear rod 4r (or the front rod 4f, the intermediate rod 4m) from the outside, the first stopper portion 86, the second stopper portion 88, and the third stopper portion 90 can interfere with the first connecting member 18 (or the second connecting member 20). According to the configuration above, the outer surfaces of the first stopper portion 86, the second stopper portion 88, and the third stopper portion 90 are located inward of the outer surface of the rear rod 4r (or the front rod 4f, the intermediate rod 4m), and thus such problems can be prevented.

In one or more embodiments, the retaining member 78 comprises a first press-fit portion 92, a second press-fit portion 94, and a third press-fit portion 96 configured to be inserted in the interior of the rear rod 4r (or the front rod 4f, the intermediate rod 4m) through the one end of the rear rod 4r (or the front rod 4f, the intermediate rod 4m) and be pressed between the outer surface of the first connector housing 68 and an inner surface of the rear rod 4r (or the front rod 4f, the intermediate rod 4m).

Since the first connector housing 68 is configured to pass through the interior of the rear rod 4r (or the front rod 4f, the intermediate rod 4m), a clearance is provided between the outer surface of the first connector housing 68 and the inner surface of the rear rod 4r (or the front rod 4f, the intermediate rod 4m). Without this clearance being filled, the first connector housing 68 may play against the rear rod 4r (or the front rod 4f, the intermediate rod 4m). According to the configuration above, the clearance is at least partially filled by the first press-fit portion 92, the second press-fit portion 94, and the third press-fit portion 96. This suppresses the first connector housing 68 from playing against the rear rod 4r (or the front rod 4f, the intermediate rod 4m).

In one or more embodiments, the one end of the rear rod 4r (or the front rod 4f, the intermediate rod 4m) comprises a notch 100 configured to receive the third stopper portion 90 in the front-rear direction.

The configuration above suppresses the first connector housing 68 from moving in a circumferential direction of the rear rod 4r (or the front rod 4f, the intermediate rod 4m) by the notch 100 receiving the third stopper portion 90. Therefore, the rear rod 4r (or the front rod 4f, the intermediate rod 4m) and the first connector housing 68 are positioned relative to each other in the circumferential direction of the rear rod 4r (or the front rod 4f, the intermediate rod 4m).

In one or more embodiments, the working machine 2, 302, 402, 502 further comprises a first connecting member 18 (or a second connecting member 20) disposed at the one end of the rear rod 4r (or the front rod 4f, the intermediate rod 4m). The first connecting member 18 (or the second connecting member 20) comprises a cylindrical portion 136 into which the one end of the rear rod 4r (or the front rod 4f, the intermediate rod 4m) is inserted. The retaining member 78 comprises a guide projection 98 protruding outward beyond the outer surface of the rear rod 4r (or the front rod 4f, the intermediate rod 4m) as viewed along the front-rear direction. The cylindrical portion 136 comprises a rear guide groove 152 (an example of guide groove) configured to slidably receive the guide projection 98 in the front-rear direction.

The configuration above suppresses the first connector housing 68 from moving in a circumferential direction of the cylindrical portion 136 by the rear guide groove 152 receiving the guide projection 98. Therefore, the first connecting member 18 (or the second connecting member 20) and the first connector housing 68 are positioned relative to each other in the circumferential direction of the cylindrical portion 136.

In one or more embodiments, the working machine 2, 302, 402, 502 further comprises a first connecting member 18 (or a second connecting member 20) disposed at the one end of the rear rod 4r (or the front rod 4f, the intermediate rod 4m). The first connecting member 18 (or the second connecting member 20) comprises a cylindrical portion 136 into which the one end of the rear rod 4r (or the front rod 4f, the intermediate rod 4m) is inserted. The cylindrical portion 136 comprises an inward flange 158 (an example of support portion) configured to contact the first stopper portion 86, the second stopper portion 88, and the third stopper portion 90 from an opposite side to a side at which the one end of the rear rod 4r (or the front rod 4f, the intermediate rod 4m) contacts the first stopper portion 86, the second stopper portion 88, and the third stopper portion 90.

According to the configuration above, the first stopper portion 86, the second stopper portion 88, and the third stopper portion 90 are interposed between the one end of the rear rod 4r (or the front rod 4f, the intermediate rod 4m) and the inward flange 158 of the cylindrical portion 136 in the front-rear direction. This suppresses the first connector housing 68 from moving relative to the rear rod 4r (or the front rod 4f, the intermediate rod 4m) and the first connecting member 18 (or the second connecting member 20) in the front-rear direction. Therefore, the first connector housing 68 is positioned relative to the rear rod 4r (or the front rod 4f, the intermediate rod 4m) and the first connecting member 18 (or the second connecting member 20) in the front-rear direction.

In one or more embodiments, the retaining member 78 comprises a band portion 80 extending over more than a half of a periphery of the first connector housing 68, a first engaging portion 82 protruding from one end of the band portion 80 toward the first connector housing 68, and a second engaging portion 84 protruding from the other end of the band portion 80 toward the first connector housing 68. The first connector housing 68 comprises a first engagement groove 108 (an example of first recess) corresponding to the first engaging portion 82 and a second engagement groove 110 (an example of second recess) corresponding to the second engaging portion 84. In a state where the band portion 80 is expanded radially outward by an outer surface of the first connector housing 68, the first engaging portion 82 engages the first engagement groove 108 and the second engaging portion 84 engages the second engagement groove 110.

Attaching the retaining member 78 to the first connector housing 68 could be considered using a fastener such as a pin. However, this increases the number of components and thus increases the manufacturing cost of the working machine2, 302, 402, 502. According to the configuration above, the retaining member 78 can be attached to the first connector housing 68 by using the elasticity of the retaining member 78, without using a fastener. This allows for a reduction in the number of components and thus a reduction in the manufacturing cost of the working machine2, 302, 402, 502.

In one or more embodiments, the other end of the rear rod 4r (or the front rod 4f, the intermediate rod 4m) is attached to the rear unit 8 or the front unit 6 in a difficult-to-remove manner.

A relatively heavy element (e.g., a battery pack B) is expected to be provided in the rear unit 8 (or the front unit 6). Therefore, the connection between the operation rod 4 and the rear unit 8 (or the front unit 6) is expected to bear a relatively large load. If the operation rod 4 is attached to the rear unit 8 (or the front unit 6) in an easy-to-remove manner, it is difficult to ensure rigidity that can bear the above load at the connection therebetween. According to the configuration above, the operation rod 4 is attached to the rear unit 8 (or the front unit 6) in a difficult-to-remove manner. In this configuration, the operation rod 4 can be attached to the rear unit 8 (or the front unit 6) relatively firmly. Therefore, rigidity that can bear the above load can be easily ensured at the connection between the operation rod 4 and the rear unit 8 (or the front unit 6).

In one or more embodiments, the working machine 2, 302 further comprises an intermediate rod 4m (or a rear rod 4r, a front rod 4f) (an example of second operation rod) extending in the front-rear direction and disposed between the front unit 6 and the rear unit 8 and an intermediate wire 56m (or a rear wire 56r, a front wire 56f) (an example of second wire) disposed in an interior of the intermediate rod 4m (or the rear rod 4r, the front rod 4f). The intermediate rod 4m (or the rear rod 4r, the front rod 4f) is configured such that one end of the intermediate rod 4m (or the rear rod 4r, the front rod 4f) is detachably attached to the one end of the rear rod 4r (or the front rod 4f, the intermediate rod 4m). The intermediate wire 56m (or the rear wire 56r, the front wire 56f) is electrically connected to the plurality of second terminals 118. The second connector housing 120 is retained at the one end of the intermediate rod 4m (or the rear rod 4r, the front rod 4f).

The size of the working machine 2, 302 with the operation rod 4 tends to be large in the front-rear direction. Therefore, the working machine 2, 302 may be difficult to store (or pack). The configuration above allows the working machine 2, 302 to be separated into the rear rod 4r (or the front rod 4f, the intermediate rod 4m) and the intermediate rod 4m (or the rear rod 4r, the front rod 4f). This separation reduces the size of the working machine 2, 302 in the front-rear direction. Therefore, the working machine 2, 302 can be easily stored (or packed).

In one or more embodiments, the other end of the intermediate rod 4m (or the rear rod 4r, the front rod 4f) is attached to the front unit 6 or the rear unit 8 in a difficult-to-remove manner.

A relatively heavy element (e.g., an electric motor 24) is expected to be provided in the front unit 6 (or the rear unit 8). Therefore, the connection between the operation rod 4 and the front unit 6 (or the rear unit 8) is expected to bear a relatively large load. If the operation rod 4 is attached to the front unit 6 (or the rear unit 8) in an easy-to-remove manner, it is difficult to ensure rigidity that can bear the above load at the connection therebetween. According to the configuration above, the operation rod 4 is attached to the front unit 6 (or the rear unit 8) in a difficult-to-remove manner. In this configuration, the operation rod 4 can be attached to the front unit 6 (or the rear unit 8) relatively firmly. Therefore, the rigidity that can bear the above load can be easily ensured at the connection between the operation rod 4 and the front unit 6 (or the rear unit 8).

In one or more embodiments, the working machine 2 further comprises a front rod 4f (or an intermediate rod 4m, a rear rod 4r) (an example of third operation rod) extending in the front-rear direction and disposed between the front unit 6 and the rear unit 8. The front rod 4f (or the intermediate rod 4m, the rear rod 4r) is configured such that one end of the front rod 4f (or the intermediate rod 4m, the rear rod 4r) is detachably attached to the other end of the intermediate rod 4m (or the rear rod 4r, the front rod 4f).

The configuration above allows the working machine 2 to be separated not only into the rear rod 4r (or the front rod 4f, the intermediate rod 4m) and the intermediate rod 4m (or the rear rod 4r, the front rod 4f) but also into the front rod 4f (or the intermediate rod 4m, the rear rod 4r). Therefore, the working machine 2 can be further reduced in size and thus the working machine 2 can be more easily stored (or packed).

In one or more embodiments, the other end of the front rod 4f (or the intermediate rod 4m, the rear rod 4r) is attached to the front unit 6 or the rear unit 8 in a difficult-to-remove manner.

A relatively heavy element (e.g., an electric motor 24) is expected to be provided in the front unit 6 (or the rear unit 8). Therefore, the connection between the operation rod 4 and the front unit 6 (or the rear unit 8) is expected to bear a relatively large load. If the operation rod 4 is attached to the front unit 6 (or the rear unit 8) in an easy-to-remove manner, it is difficult to ensure rigidity that can bear the above load at the connection therebetween. According to the configuration above, the operation rod 4 is attached to the front unit 6 (or the rear unit 8) in a difficult-to-remove manner. In this configuration, the operation rod 4 can be attached to the front unit 6 (or the rear unit 8) relatively firmly. Therefore, the rigidity that can bear the above load can be easily ensured at the connection between the operation rod 4 and the front unit 6 (or the rear unit 8).

In one or more embodiments, the rear unit 8 comprises a power interface 52 configured to be electrically connected to a power source. The rear wire 56r (or the front wire 56f, the intermediate wire 56m) functions as at least a part of a power transmission path between the working part 14 and the power interface 52.

The front unit 6 could be configured to include the power interface 52. In this configuration, however, the weight of the front unit 6 is increased because elements for power supply (e.g., a battery pack B, a power cable) are attached to the front unit 6. This may decrease handleability of the working part 14, which is located at the front unit 6. According to the configuration above, the rear unit 8 includes the power interface 52. Since there is no need to attach the elements for power supply to the front unit 6, the weight of the front unit 6 can be reduced. This improves handleability of the working part 14.

What is claimed is:

1. A working machine, comprising:
a first operation rod extending in a front-rear direction;
a front unit disposed frontward of the first operation rod and comprising a working part;
a rear unit disposed rearward of the first operation rod;
a first wire disposed in an interior of the first operation rod;
a first terminal electrically connected to the first wire;
a first connector housing holding the first terminal and configured to pass through the interior of the first operation rod in the front-rear direction;
a retainer configured to retain the first connector housing at one end of the first operation rod;
a second terminal; and
a second connector housing holding the second terminal and configured to be detachably attached to the first connector housing,
wherein the first terminal and the second terminal are electrically connected to each other by the first connector housing and the second connector housing being attached to each other.

2. The working machine according to claim 1, wherein
the retainer comprises a retaining member configured to be detachably attached to the first connector housing, and
the retaining member is configured to retain the first connector housing at the one end of the first operation rod.

3. The working machine according to claim 2, wherein
the retaining member comprises a stopper portion that protrudes outward beyond an outer surface of the first connector housing when the retaining member is attached to the first connector housing, and
the first connector housing is retained at the one end of the first operation rod by the stopper portion contacting the first operation rod in the front-rear direction.

4. The working machine according to claim 3, wherein
the stopper portion comprises:
a first stopper portion; and
a second stopper portion circumferentially offset from the first stopper portion.

5. The working machine according to claim 4, wherein
the stopper portion further comprises a third stopper portion circumferentially offset from each of the first stopper portion and the second stopper portion.

6. The working machine according to claim 3, wherein
an outer surface of the stopper portion is located inward of an outer surface of the first operation rod as viewed along the front-rear direction.

7. The working machine according to claim 3, wherein
the retaining member comprises a press-fit portion configured to be inserted in the interior of the first operation rod through the one end of the first operation rod and be pressed between the outer surface of the first connector housing and an inner surface of the first operation rod.

8. The working machine according to claim 3, wherein
the one end of the first operation rod comprises a notch configured to receive the stopper portion in the front-rear direction.

9. The working machine according to claim 3, further comprising a connecting member disposed at the one end of the first operation rod,
wherein
the connecting member comprises a cylindrical portion into which the one end of the first operation rod is inserted,
the retaining member comprises a guide projection protruding outward beyond an outer surface of the first operation rod as viewed along the front-rear direction, and
the cylindrical portion comprises a guide groove configured to slidably receive the guide projection in the front-rear direction.

10. The working machine according to claim 3, further comprising a connecting member disposed at the one end of the first operation rod,
wherein
the connecting member comprises a cylindrical portion into which the one end of the first operation rod is inserted, and
the cylindrical portion comprises a support portion configured to contact the stopper portion from an opposite side to a side at which the one end of the first operation rod contacts the stopper portion.

11. The working machine according to claim 2, wherein
the retaining member comprises:
a band portion extending over more than a half of a periphery of the first connector housing;
a first engaging portion protruding from one end of the band portion toward the first connector housing; and
a second engaging portion protruding from other end of the band portion toward the first connector housing,
the first connector housing comprises:
a first recess corresponding to the first engaging portion; and
a second recess corresponding to the second engaging portion, and
in a state where the band portion is expanded radially outward by an outer surface of the first connector housing, the first engaging portion engages the first recess and the second engaging portion engages the second recess.

12. The working machine according to claim 1, wherein
other end of the first operation rod is attached to the rear unit or the front unit in a difficult-to-remove manner.

13. The working machine according to claim 1, further comprising:
a second operation rod extending in the front-rear direction and disposed between the front unit and the rear unit; and
a second wire disposed in an interior of the second operation rod,
wherein
the second operation rod is configured such that one end of the second operation rod is detachably attached to the one end of the first operation rod,
the second wire is electrically connected to the second terminal, and
the second connector housing is retained at the one end of the second operation rod.

14. The working machine according to claim 13, wherein
other end of the second operation rod is attached to the front unit or the rear unit in a difficult-to-remove manner.

15. The working machine according to claim 13, further comprising a third operation rod extending in the front-rear direction and disposed between the front unit and the rear unit,
wherein
the third operation rod is configured such that one end of the third operation rod is detachably attached to other end of the second operation rod.

16. The working machine according to claim 15, wherein
other end of the third operation rod is attached to the front unit or the rear unit in a difficult-to-remove manner.

17. The working machine according to claim 1, wherein
the rear unit comprises a power interface configured to be electrically connected to a power source, and
the first wire functions as at least a part of a power transmission path between the working part and the power interface.

18. The working machine according to claim 5, wherein
an outer surface of the stopper portion is located inward of an outer surface of the first operation rod as viewed along the front-rear direction,
the retaining member comprises a press-fit portion configured to be inserted in the interior of the first operation rod through the one end of the first operation rod and be pressed between the outer surface of the first connector housing and an inner surface of the first operation rod,
the one end of the first operation rod comprises a notch configured to receive the stopper portion in the front-rear direction,
the working machine further comprises a connecting member disposed at the one end of the first operation rod,
the connecting member comprises a cylindrical portion into which the one end of the first operation rod is inserted,
the retaining member comprises a guide projection protruding outwardly beyond an outer surface of the first operation rod as viewed along the front-rear direction,
the cylindrical portion comprises a guide groove configured to slidably receive the guide projection in the front-rear direction,
the cylindrical portion comprises a support portion configured to contact the stopper portion from an opposite side to a side at which the one end of the first operation rod contacts the stopper portion,
the retaining member comprises:
a band portion extending over more than a half of a periphery of the first connector housing;
a first engaging portion protruding from one end of the band portion toward the first connector housing; and
a second engaging portion protruding from other end of the band portion toward the first connector housing,
the first connector housing comprises:
a first recess corresponding to the first engaging portion; and
a second recess corresponding to the second engaging portion,
in a state where the band portion is expanded radially outward by an outer surface of the first connector housing, the first engaging portion engages the first recess and the second engaging portion engages the second recess,
other end of the first operation rod is attached to the rear unit or the front unit in a difficult-to-remove manner,
the working machine further comprises:
a second operation rod extending in the front-rear direction and disposed between the front unit and the rear unit; and
a second wire disposed in an interior of the second operation rod,
the second operation rod is configured such that one end of the second operation rod is detachably attached to the one end of the first operation rod,
the second wire is electrically connected to the second terminal,
the second connector housing is retained at the one end of the second operation rod,
the working machine further comprises a third operation rod extending in the front-rear direction and disposed between the front unit and the rear unit,
the third operation rod is configured such that one end of the third operation rod is detachably attached to other end of the second operation rod,
other end of the third operation rod is attached to the front unit or the rear unit in a difficult-to-remove manner,
the rear unit comprises a power interface configured to be electrically connected to a power source, and
the first wire functions as at least a part of a power transmission path between the working part and the power interface.
